(19) United States
(12) Patent Application Publication
(10) Pub. No.: US 2019/0005569 A1
(43) Pub. Date: Jan. 3, 2019

(54) METHODS AND SYSTEMS FOR AUTOMATICALLY MAPPING A RETAIL LOCATION

(71) Applicant: PetSmart Home Office, Inc., Phoenix, AZ (US)

(72) Inventors: Vivek Reddy Kotha, Peoria, AZ (US); Bret Lewis Sherman, JR., Tempe, AZ (US); Harold Wayne Fleenor, III, Scottsdale, AZ (US); Charles Christopher Ingram, Scottsdale, AZ (US)

(21) Appl. No.: 16/021,851

(22) Filed: Jun. 28, 2018

Related U.S. Application Data
(60) Provisional application No. 62/525,938, filed on Jun. 28, 2017.

(51) Int. Cl. G06Q 30/06; G06F 17/30; G01C 21/20

(52) U.S. Cl. CPC G06Q 30/0639; G06Q 30/0641; G01C 21/206; G06F 17/30241

(57) ABSTRACT

A product location system includes a computing device, and a computer-readable storage medium. The system identifies a retail location associated with a retailer, receives an indication of a target product that is to be located in the retail location, queries a product data store using the indication to identify the target product and a location of the target product in the retail location, retrieves a map of the retail location, where the map includes one or more electronic files and embedded metadata, modifies the map to include a visual indication associated with location of the target product, and causes the modified map to be displayed via the client electronic device such that the visual indication showing the location of the target product in the retail location is visible to a user via the client electronic device.

### RELATED APPLICATIONS AND CLAIM OF PRIORITY

This patent document claims priority to U.S. Provisional Patent Application No. 62/525,938, filed Jun. 28, 2017, the disclosure of which is fully incorporated in its entirety into this document by reference.

### BACKGROUND

Quickly finding a particular product in a retail location can be difficult for a customer or a sales associate assisting a customer. This is especially true for large retailers that carry large and diverse product lines, or locations that have recently renovated or reorganized their spaces. While signage of general product categories can generally direct a customer to the right part of the retail location, electronically pinpointing the exact location of a particular product in the retail location and providing directions to such location more efficiently helps a customer navigate a retail location and provides a more efficient and customer-friendly shopping experience.

### SUMMARY

This disclosure describes a system for automatically mapping the inside of a retail location. The system generates a data object that includes embedded metadata corresponding to a retail location such as, for example, product locations, physical features or landmarks. The data object can be used to generate an electronic map of the retail location. The map can be used to identify the location of one or more products within the retail location. The system provides a visual representation of a product location to a user. The system can also provide a user with turn-by-turn directions to a product location. The system may provide a user with such information in response to a product search, as part of an email message to the user, or in connection with an electronic digital assistant, among other situations.

In an embodiment, a product location system includes a computing device, and a computer-readable storage medium. The computer-readable storage medium includes one or more programming instructions that, when executed, cause the computing device to identify a retail location associated with a retailer, receive an indication of a target product that is to be located in the retail location, where the product location system receives the indication from a product location program of a client electronic device that is in communication with the computing device via a communication network, query a product data store using the indication to identify the target product and a location of the target product in the retail location, retrieve a map of the retail location, where the map includes one or more electronic files and embedded metadata, modify the map to include a visual indication associated with location of the target product, and cause the modified map to be displayed via the client electronic device such that the visual indication showing the location of the target product in the retail location is visible to a user via the client electronic device.

The system may cause the computing device to generate the map of the retail location. The system may generate the map of the retail location by obtaining physical data associated with the retail location, and obtaining product placement information associated with the retail location, where the product placement information includes one or more planograms. The system may group the one or more planograms into one or more groupings, apply one or more rotations to one or more planograms of the one or more groupings, and create one or more aisle objects, where each aisle object includes an indication of one or more groupings that include a side of an aisle of the retail location. The system may embed a unique identifier as metadata in the aisle object, where the unique identifier corresponds to an aisle number in the retail location, and create the map, where the map includes a scalable vector graphic and extensible markup language document that includes one or more of the planograms and the aisle objects.

In an embodiment, the system may identify a retail location by receiving an indication of the retail location from a client electronic device. In an embodiment, the system may identify a retail location by receiving a current location from a location sensor of a client electronic device, and identifying one or more retail locations by searching a retail location data store for one or more retail locations within a certain distance from the current location. The system may select the retail location in closest proximity to the current location. In various embodiments, the system may cause a list of identified retail locations to be displayed at a client electronic device, and may receive from the client electronic device a selection of one of the retail locations.

The system may identify a retail location by identifying a user associated with the client electronic device, and identifying a home retail location from a customer profile associated with the user. In various embodiments, the system may receive, from the client electronic device, a universal product code associated with the target product.

The system may receive, from the client electronic device, one or more search terms for the target product that were provided to the client electronic device as typed text, and query the product data store using one or more of the one or more search terms.

In an embodiment, the system may receive, from the client electronic device, one or more search terms for the target product that were provided to the client electronic device as spoken input, and query the product data store using one or more of the typed search terms.

The system may receive an indication of a target product to be located by identifying a user associated with the client electronic device, and searching a historical purchase data store for one or more products previously purchased by the user from the retailer.

Optionally, the system may identify a start location, generate a set of directions from the start location to the location of the target product, and cause the set of directions to be displayed via the client electronic device. The system may identify a default start location as the start location. In various embodiments, the system may identify a start location by determining a current location of a client electronic device by identifying a wireless access point in the retail location to which the client electronic device is connected.

In an embodiment, a product location system may locate a product in a retail location by receiving, from an inventory management system, a notification that an on-shelf inventory of a product in a retail location is low, in response to receiving the notification, retrieving a map of the retail location, modifying the map to include a visual indication associated with a location of the product, causing the modified map to be displayed at one or more client electronic devices associated with the retail location, and causing a low inventory notification to be displayed at the one or more client electronic devices.

In various embodiments, a product location system may locate a product in a retail location by receiving, from an electronic digital assistant associated with a user, an instruction pertaining to a target product sold by a retailer, identifying a retail location associated with the retailer, querying a product data store using the instruction to identify the target product and a location of the target product in the retail location, retrieving a map of the retail location, modifying the map to include an visual indication associated with location of the target product; and causing the modified map to be displayed via a client electronic device associated with the user.

In an embodiment, a product location system may locate a product in a retail location by receiving an indication from a wireless access point in a retail location that a client electronic device has been detected, where the indication includes a unique identifier associated with the client electronic device, using the unique identifier associated with the client electronic device to identify a user associated with the client electronic device, accessing a historical purchase data store to determine whether the user purchased one or more products at the retail location during a past period of time, accessing a customer profile data store to determine whether a profile of the user indicates that the retail location is a home location associated with the user, and in response to determining that the user has not purchased one or more products at the retail location during the past period of time and that the retail location is not the home location associated with the user, causing a map of the retail location to be displayed via the client electronic device.

### BRIEF DESCRIPTION OF THE DRAWINGS

FIGS. 1A and 1B illustrate example methods of generating a map of a retail location according to various embodiments.

FIG. 2 illustrates an example planogram according to an embodiment.

FIG. 3 illustrates an example map of a retail location according to an embodiment.

FIG. 4 illustrates an example system for locating a product in a retail location according to an embodiment.

FIG. 5 illustrates an example method of locating a product in a retail location according to an embodiment.

FIG. 6 illustrates an example map showing the location of a particular product in a retail location according to an embodiment.

FIGS. 7A and 7B illustrate examples of graphical user interfaces (GUI) that may be displayed to a user of a product locating program according to an embodiment.

FIG. 8 illustrates a diagram showing an example location service according to an embodiment.

FIG. 9 illustrates an example inventory management system and product location system according to an embodiment.

FIG. 10 illustrates an example method of generating an inventory alert according to an embodiment.

FIG. 11 illustrates an example notification system according to an embodiment.

FIG. 12 illustrates a product location system in communication with an electronic digital assistant application according to an embodiment.

FIG. 13 illustrates an example method of generating a map in connection with a to-do list according to an embodiment.

FIG. 14 illustrates a block diagram of example hardware that may be used to contain or implement program instructions according to an embodiment.

FIGS. 15 and 16 illustrate example planogram diagrams according to various embodiments.

FIG. 17 illustrates an example flow according to an embodiment.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions. Examples of electronic devices include personal computers, servers (local or cloud-based), mainframes, virtual machines, containers, gaming systems, televisions, and mobile electronic devices such as smartphones, personal digital assistants, cameras, tablet computers, laptop computers, media players and the like. In a client-server arrangement, the client device and the server are each electronic devices, in which the server contains instructions and/or data that the client device accesses via one or more communications links in one or more communications networks. In a virtual machine arrangement, a server may be an electronic device, and each virtual machine or container may also be considered to be an electronic device. In the discussion below, a client device, server device, virtual machine or container may be referred to simply as a “device” for brevity.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

A “retail location” refers to an environment where good, products and/or the like are sold, stored or otherwise made available. Example retail environments may include, without limitation, retail store locations, warehouses, and/or the like.

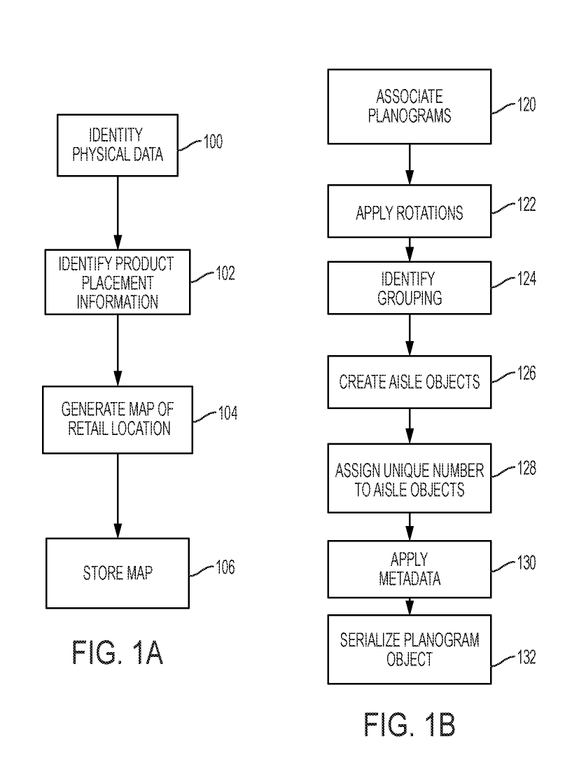

FIG. 1A illustrates an example method of generating a map of a retail location according to an embodiment. As illustrated by FIG. 1A, a system may identify 100 physical data associated with a retail location. Physical data refers to information pertaining to a floor plan or physical layout of a retail location. Examples of physical data may include, for example, coordinates, dimensions or locations of rooms (e.g., sale space, bathrooms, stock rooms, break rooms, etc.), doors and windows, entrances and exits and/or the like.

Physical data associated with a retail location may be stored in one or more data stores. Physical data may be stored as raw data, such as measurements or coordinates. Physical data may also be stored as one or more diagrams, such as an architecture diagram, a floorplan, a computer-aided design diagram and/or the like. Physical data may be keyed to a particular retail location in a data store. For example, a data store may be a relational database that stores physical data that is keyed to a unique identifier representing a particular retail location. A system may identify 100 physical data associated with a retail location by searching one or more data stores for physical data associated with the retail location. For example, a system may identify 100 physical data associated with a retail location by searching a data store for physical data associated with a unique identifier associated with a particular retail location.

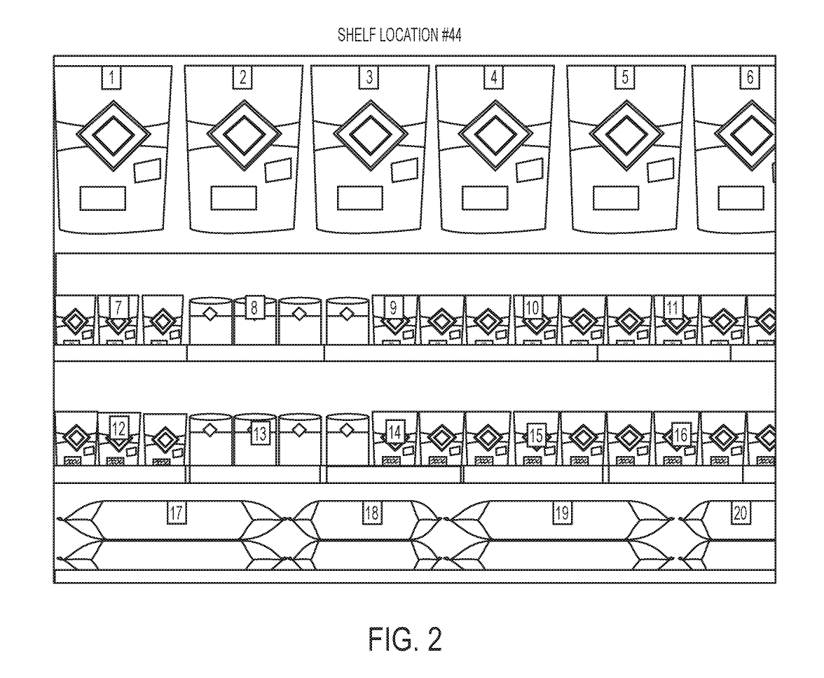

A system may identify 102 product placement information for one or more products in a retail location. Product placement information may include a planogram to which a product belongs, coordinates associated with the planogram to which the product belongs, coordinates of where a product is located in a retail environment or within a planogram, where in a display a product is located (e.g., shelf location), and/or the like. A planogram refers to an electronic, visual representation that indicates the placement of one or more products on one or more shelves. A planogram (or planogram object, as the term is used in this disclosure) may be an electronic data structure represented as a diagram, a model, a picture, an image and/or the like showing the placement of one or more products on one or more shelves or other displays and/or an orientation (e.g., one or more angles) of one or more products relative to a display, such as a front surface of a display. FIG. 2 illustrates an example planogram according to an embodiment.

Product placement information associated with a retail location may be stored in one or more data stores. Product placement information may be stored as raw data, such as a shelf identifier, coordinates of a product on a shelf, coordinates associated with a planogram corresponding to a product and/or the like. One or more planograms may be stored by one or more data stores.

Table 1 illustrates a portion of an example data store according to an embodiment. As illustrated by Table 1, the product placement information may be keyed to a particular product and/or a particular retail location in a data store. For example, a data store may be a relational database that stores product placement information that is keyed to a unique identifier representing a particular retail location and/or a unique identifier associated with a particular product. As shown by Table 1, a product identified by SKU#2341523 is associated with Planogram M. Planogram M has coordinates within the retail location of (x1, y73, z90), and the product is located within Planogram M at coordinates (x3, y5, z7).

TABLE 1

| | | | | Coordinates |
|---|---|---|---|---|
| Retail | Product | | Planogram | within |
| location | identifier | Planogram | coordinates | planogram |
| Retail | SKU# | Planogram M | (x1, y73, z90) | (x3, y5, z7) |
| Location 1 | 2341523 | | | |
| Retail | SKU# | Planogram M | (x1, y73, z90) | (x2, y7, z9) |
| Location 1 | 2341528 | | | |
| Retail | SKU# | Planogram R | (x4, y32, z52) | (x23, y12, z10) |
| Location 1 | 542839 | | | |

A system may identify 102 product placement information associated with a retail location by searching one or more data stores for product placement information associated with the retail location.

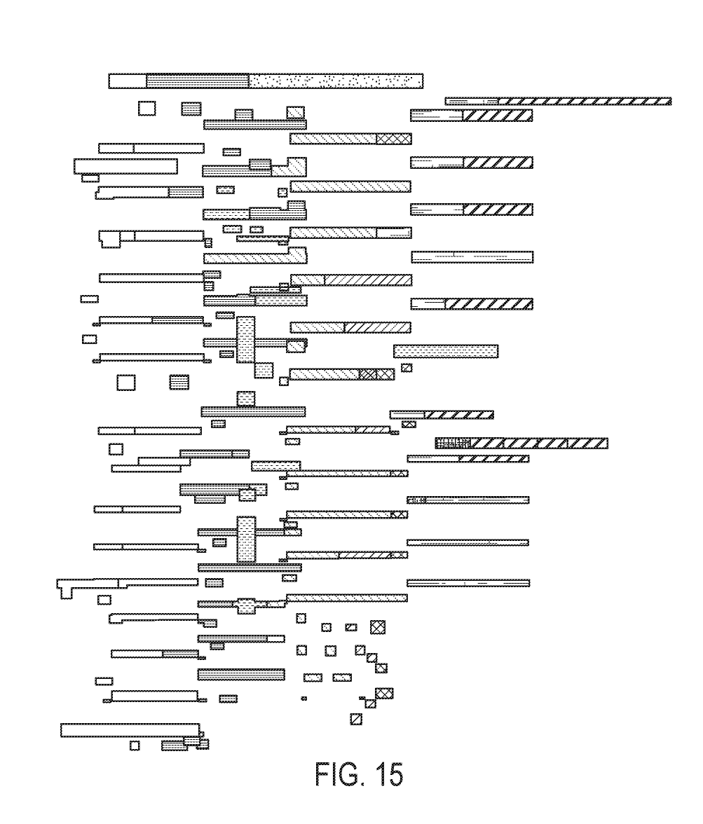

In various embodiments, product placement information may include an electronic diagram of the placement of planograms within a retail location. This planogram diagram may be created with user input. For instance, a store designer or other user may create a planogram that includes certain products. A user may place the planogram into a location in the planogram diagram. A planogram diagram may show the positioning of planograms relative to one another. FIG. 15 illustrates an example of a planogram diagram according to an embodiment.

Referring back to FIG. 1A, a system may generate 104 a map of a retail location based on at least a portion of the identified physical data and/or the identified product placement information. The system may use measurements from the physical data and measurements and/or locations of planograms from the product placement information to generate 104 a map of a retail location. The map may show details of at least a portion of the interior of a retail location. For example, a map may show the location of one or more shelves or displays, one or more aisles, one or more end caps, one or more product displays and/or the like. The map may show the location of one or more exits or entrances, checkout locations or other points of interest of the retail location.

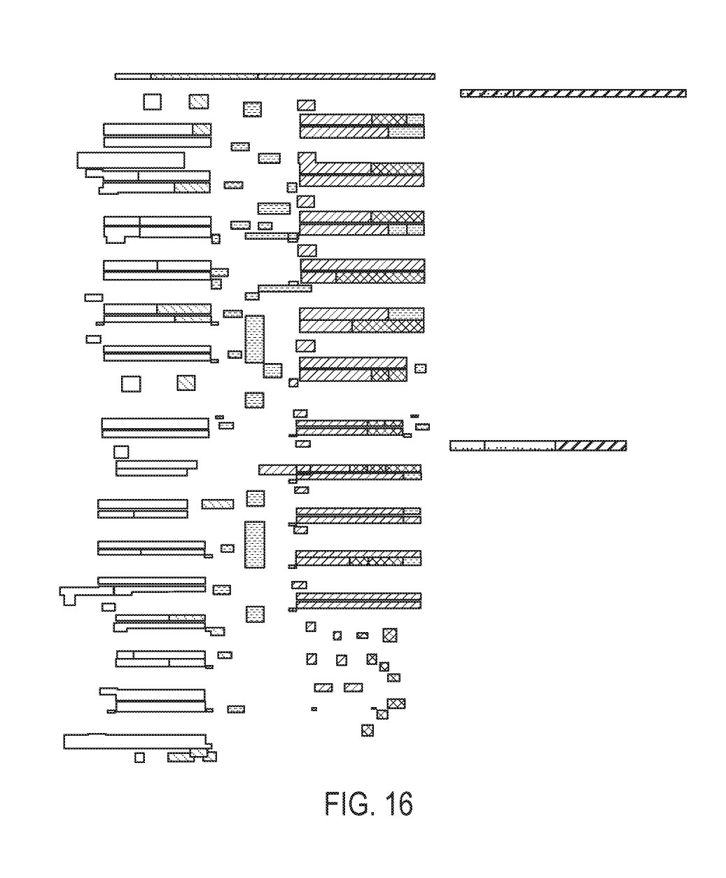

In various embodiments, a system may generate 104 a map of a retail location by applying intelligence to at least a portion of the identified physical data and/or the identified product placement information. For instance, the system may apply one or more rules or sets of rules to the identified physical data and/or the identified product placement information to generate 104 a map. For example, a system may apply one or more rules to a planogram diagram to interpret and/or organize individual planograms into a retail location layout. For instance, certain individual planograms shown in a planogram diagram may be merged or otherwise consolidated to form an aisle. Similarly, planograms located across from one another may be identified as sides of a single aisle. FIG. 16 illustrates the planogram diagram of FIG. 15 that has been processed by applying example intelligence according to an embodiment.

FIG. 1B illustrates an example method of generating 104 a map according to an embodiment. As shown in FIG. 1B, the system may logically associate 120 planograms into one or more groupings forming a planogram object structure. In various embodiments, a system may associate 120 planograms based on coordinates, labels, angle similarity, alignment threshold values and/or the like. For example, an alignment threshold value may refer to a distance or angle tolerance needed for a specific relationship to exist between planograms or planogram groupings. As an example, if an aisle planogram group is within two feet of the right edge of a planogram having a label indicating that it is an end cap, then the aisle planogram group may be considered to be the right end cap of that aisle. An angle difference of approximately 90 degrees (within the threshold) to the row aisles may indicate that the aisle planogram group is facing the center aisle. In this example, an angle refers to a number of degrees required to rotate a planogram around its relative position to the planogram group to which it belongs in order to determine its true position (e.g., in feet) inside of a retail location.

The system may apply 122 one or more rotations to one or more planograms in one or more of the groupings. The rotations may be based on the angle of a planogram, and the relative position of a planogram within a grouping. The position of a planogram may refer to a position or location of a bottom left corner of a planogram. For example, if a retail location is oriented such that the door is at the bottom of a map, and the bottom left corner is defined by coordinates (0,0), then the x-coordinate refers to the number of feet when drawings a perpendicular line from the planogram position to the left side of the retail location, and the y-coordinate refers to the number of feet when drawing a perpendicular line from the planogram position to the bottom edge of the retail location that includes the door.

Relative position, calculated as a vector, may be the difference between the planogram absolute position and the planogram group absolute position. When this vector is rotated, the absolute coordinates of the planogram may be determined.

As an example, a planogram group may start 10 feet from the left side of a retail location and 50 feet from the front of the retail location, and a position of a planogram associated with the group may be defined as 15 feet from the left side of the store and 50 feet from the front, with an angle of 90 degrees. The relative position of the planogram to the planogram group may be represented as (x, y)=(5, 0). Rotating this vector by 90 degrees may yield (0, 5). Adding this to the absolute coordinates of the planogram group may place the planogram at 10 feet from the left side of the retail location and 55 feet from the front of the retail location.

In an embodiment, the system may identify 124 one or more planogram groupings that are sides of an aisle. For instance, a system may identify 124 a planogram grouping as a side of an aisle based on one or more rules that define characteristics of an aisle such as, for instance, dimensions of the grouping, an orientation of the grouping, a distance from the grouping to one or more boundaries of the retail location and/or the like. For instance, two planogram groups may be identified as a side of an aisle by meeting a minimum size requirement to be an aisle side, either pair with an opposing side of similar length, or be sufficiently close to a wall. Furthermore, those two planogram groups, now identified as aisle sides, may be associated to form an aisle if they are similar in size, parallel within a threshold, their orientation is approximately 180 degrees (i.e. store front facing and back facing), and separated by a distance that is a likely aisle width for pedestrians.

As another example, a rule may be that if two or more planograms are adjacent to one another, they may be considered part of the same aisle. As another example, a rule may be that if a planogram is located within a threshold distance across from another planogram that these are considered to be different sides of a single aisle. Additional and/or alternate rules may be used within the scope of this disclosure.

Using the planogram groupings that are identified 124 as sides of an aisle, the system may create 126 aisle objects. The aisle objects may include an indication of the planogram groupings that comprise the sides of the aisle.

As illustrated by FIG. 1B, the system may assign 128 a unique number or other identifier to each of the aisle objects. The assigned identifier may be embedded in the aisle object as metadata. In an embodiment, the system may apply 130 metadata to one or more of the planograms. This metadata may include, for example, unique planogram identifiers associated with one or more planograms, an orientation of a planogram to a center aisle, an orientation of a planogram in a retail location, an indication of whether a planogram is part of the main aisle of a retail location, an indication of whether a planogram is part of an endcap, an indication of whether a planogram is located on a wall, an indication of whether a planogram is located at a cash register, one or more coordinates or dimensions of a retail location, unique product identifiers associated with one or more products, data associated with cash register locations and/or other landmarks of a retail location and/or the like.

In various embodiments, the system may serialize 132 the planogram object structure and the aisle objects to create an electronic map. The map may be a scalable vector graphic (SVG) and extensible markup language (XML) document (SVG+XML) that contains one or more of the planogram objects, one or more of the aisle objects, the embedded metadata and/or any other relevant data. The system may insert into the map one or more markers representing other landmarks of the retail location. For instance, the system may insert data into the map that is representative of the location for one or more products, fixtures, cash registers, doors and/or the like.

The generated SVG+XML document may be one or more electronic files that include a visual representation of the map. The map may also include encoded XML attributes and elements including metadata, as described above. This configuration may allow for other systems to repurpose, extend, query and/or customize the map in powerful ways not possible with raster images. For instance, the map may be extended through journey tracking visualization by changing colors or adding additional visual elements. As another example, the map may be extended to show low inventory levels in the form of a heat map, or as a visual tool to assist in in-store pickup. In various embodiments, when a raster image is requested by caller, the system may produce raster-based images such as, for example, a portable network graphic (PNG) image.

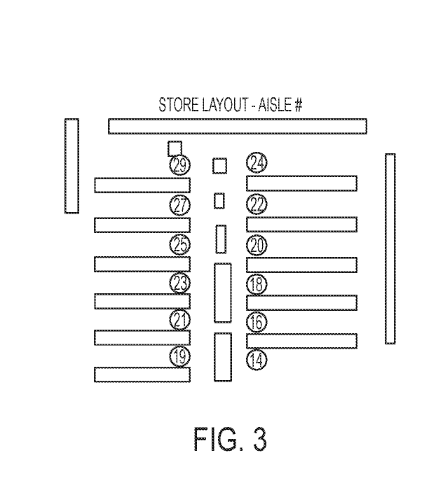

A map may illustrate product placement information for one or more products being sold by the associated retail location. FIG. 3 illustrates an example map of a retail location according to an embodiment.

The system may store 106 the generated map in one or more data stores such that it is associated with its corresponding retail location. For example, a system may store a map in a relational database such that it is keyed to a unique identifier representing a particular retail location.

In certain embodiments, a map may be used to help a consumer or retail associate locate a particular product in a retail location. A user of a client electronic device may access a product locating program via the client electronic device. A product locating program may be an application that resides on a client electronic device, such as a smartphone, tablet or other electronic device. Alternatively, a product locating program may be a website that is accessible via a client electronic device over a communications network. A communication network may be a local area network (LAN), a wide area network (WAN), a mobile or cellular communication network, an extranet, an intranet, the Internet and/or the like.

With respect to a retail associate, a product locating program may be an application that resides on one or more electronic devices present at a retail location such as, for example, tablets or other retail location electronic devices. Retail associates may use these electronic devices to help customers at the retail location find products, or customers may use these electronic devices at retail locations to assist in locating a product.

A user may provide input to a client electronic device in any suitable fashion including, without limitation, via a touch interface, a keyboard or other input device, or by speaking the input into one or more microphones of a client electronic device.

A product locating program may be specific to a company (or other organization) having one or more retail locations. For example, a product locating program may be associated with Acme Corporation, which has 2,000 retail locations nationwide. It is understood that a product locating program may be used with a different variety of businesses, companies, organizations, locations and/or the like.

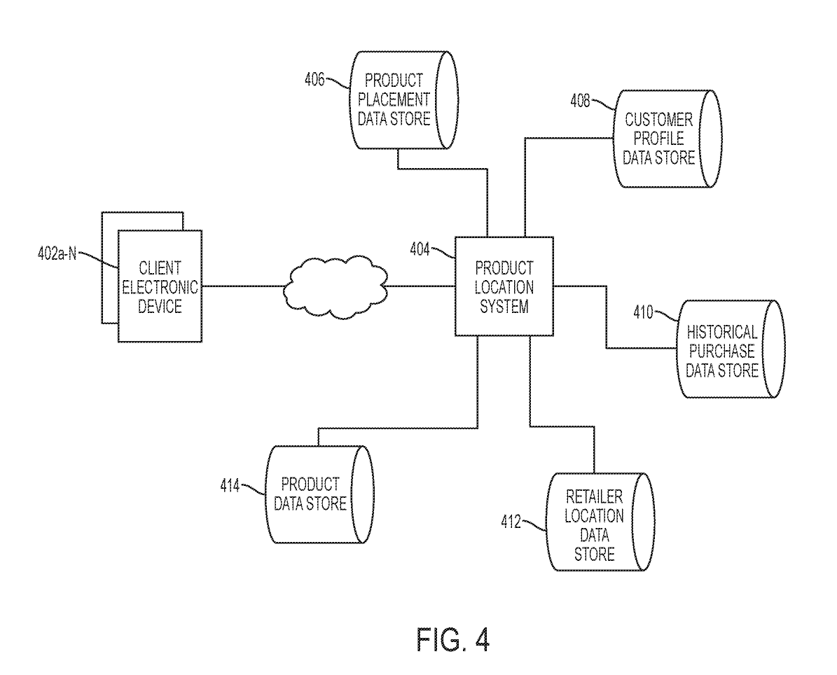

FIG. 4 illustrates an example system for locating a product in a retail location according to an embodiment. As illustrated by FIG. 4, the system 400 may include one or more client electronic devices 402a-N and a product location system 404. The product location system 404 may communicate with one or more of the client electronic devices 402a-N via a communication network 416. The product location system 404 may be implemented as one or more electronic devices. The product location system 404 may be implemented as a hosted or cloud-based solution. In such a situation, the product location system 404 may include one or more hosted servers, virtual machines and/or the like.

As illustrated by FIG. 4, the product location system 404 may have access to a product placement data store 406, a customer profile data store 408, a historical purchase data store 410, a retail location data store 412, and a product data store 414. One or more of these data stores may be a part of the product location system 404, or they may reside remotely from the product location system.

A product placement data store 406 may store product placement information associated with one or more products. Product placement information may include to information about where to find a particular product in a particular retail location. Product placement information may include, without limitation, an aisle identifier, a shelf identifier, a display identifier, one or more coordinates in a retail location, one or more coordinates in a planogram to which the product belongs and/or the like.

A customer profile data store 408 may store information about customers or potential customers of one or more retail locations. A customer profile may include information provided by a customer or potential customer, such as contact information, shopping preferences, product preferences, retail location preferences and/or the like. As an example, a customer or potential customer may register for a customer account, loyalty program, or other account with a retailer. As part of this registration process, the customer may provide the retailer with information that is included in the customer's profile. With respect to electronic accounts, a user may set a username and/or password, email or other contact preferences, a default form of payment for online purchases, billing/shipping information and/or the like.

A customer profile may store information that is keyed to a particular customer. For example, one or more customer identifiers may be used to identify customers such as, for example, a unique user name associated with a customer's account with a retailer, a unique identifier associated with a client electronic device that a customer registers with a retailer and/or the like. A customer profile may include information collected about a customer or potential customer by one or more retail locations with the customer's or potential customer's consent.

A historical purchase data store 410 may store information about past purchases or purchases previously made by customers. This information may include, without limitation, the products purchased, the dates of such purchases, the retail location(s) where the products were purchased (or an indication that products were purchased via an ecommerce platform) and/or the like.

A retail location data store 412 may store information about the locations of various retail locations. The information may include an address, positioning coordinates and/or the like. A product data store 414 stores information about products sold by one or more retail locations. Such information may include inventory information for one or more of the retail locations.

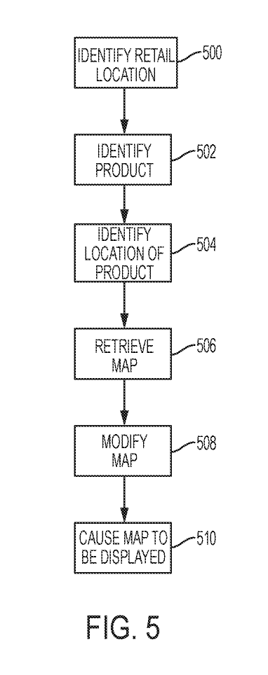

FIG. 5 illustrates an example method of locating a product in a retail location according to an embodiment. As illustrated by FIG. 5, the method may involve identifying 500 a particular retail location. A system may identify 500 a retail location by receiving an indication of a retail location via a product locating program. For instance, a user may provide a unique identifier associated with a retail location, such as a name of the retail location, an address of the retail location, or a unique identifier associated with the retail location. As another example, a user may provide a location, such as a zip code. The system may access a retail location data store or other data store to determine whether there are any retail locations within a certain distance of the zip code. If there are, the system may present the options to the user via the product locating program, and the user may select the correct retail location.

As another example, a product locating program may access a location sensor, such as, for example, a global positioning system (GPS), of a client electronic device to ascertain a current location of the client electronic device and the user. The product locating program may automatically select the nearest retail location. Alternatively, the product locating program may determine whether there are any retail locations within a certain distance of the current location. If there are, the system may present the options to the user via the product locating program, and the user may select the correct retail location.

As yet another example, a product locating program may identify a retail location that is associated with a particular user. For instance, a user may create a customer profile that is stored in one or more data stores. As part of the customer profile, the user may identify a “home” retail location. A home retail location may refer to a retail location where the user usually shops, a retail location that is nearest to a user's location and/or the like.

Referring back to FIG. 5, a system may identify 502 a product that is to be located at the identified retail location. A system may identify 502 a product by receiving an indication of a product by receiving a scan of a barcode or universal product code (UPC) associated with a product. For instance, an electronic device may include bar code scanner software that allows the electronic device to scan a UPC or other bar code. As another example, an electronic device may be in communication with a scanner that scans a UPC or other bar code.

A system may receive an indication of a product by receiving one or more search terms related to the product. For instance, a product location program may prompt a user to input one or more search terms to identify a product to find. The search terms may relate to the type of product, the name of the product, the brand of the product, a stock keeping unit (SKU) number and/or the like. The system may receive the search terms (such as, for example, typed text or spoken words/phrases), and may use at least a portion of the search terms to query one or more product data stores. A product data store stores information about one or more products that are sold by one or more retail locations. This product information may include, without limitation, a product brand, a product name, a product description, an associated UPC, a price, a SKU, an indication of one or more retail locations that sell the product, and/or a status of whether the product in currently in inventory at a particular retail location.

The system may search the product information to identify one or more products that satisfy the query. For example, if a user searches on “cat food”, the system may identify all cat food products that are sold by a retail location. As another example, if a user searches on “Company X cat food”, the system may identify all cat food products manufactured by Company X and sold by a retail location. Additional and/or alternate queries may be used within the scope of this disclosure.

In another embodiment, a system may receive an indication of a product by identifying one or more products previously purchased by a user from a retailer. Purchase history information for one or more customers may be stored in one or more historical purchase data stores. Purchase history information may include information about one or more products that a customer purchased from a retailer over a period of time. Purchase history information may include a unique identifier associated with a customer such as, for example, a loyalty program identifier, a user name, the customer's name or address and/or the like. Purchase history information may include a name of a product purchased by the customer from a retailer, a unique identifier associated with the product, a product type, a retail location where the product was purchased (or an indication that the product was bought through the retailer's ecommerce platform if so applicable), a price of the product and/or the like. A system may present to a user a list of one or more of the products previously purchased by the user, and may receive a selection of a specific product from the user.

Referring back to FIG. 5, a system may identify 504 one or more locations of the identified product at the identified retail location. In various embodiments, a product may be located in two or more different locations in a retail location. For instance, a product may have a primary location, such as a certain shelf space, in a retail location, as well as a secondary location such as, an end cap. A system may identify 504 all locations of a product. Alternatively, a system may identify a product's primary location.

A system may search a product placement data store for location information for the identified product at the retail location. For instance, a system may query a product placement data store for information about where the product is located at the pertinent retail location. Location information may include an indication of a planogram to which the identified product belongs. Location information may include an aisle where the product is located at a retail location, an indication of a particular shelf where the product is located at a retail location, coordinates of where the product is located in a retail location, and/or the like.

As an example, a system may search a data store, such as a product placement data store, for the identified product. The system identifies a planogram to which the identified product belongs. The system may retrieve from a data store, such as a product placement data store, one or more coordinates associated with the identified planogram. The coordinates indicate where the planogram is located within the retail location. The system may also retrieve one or more coordinates indicating where the identified product is located within the identified planogram. These coordinates indicate a position of the identified product from a front-facing view of the planogram (e.g., a shelf view).

The system may retrieve 506 a map associated with the identified retail location from one or more data stores. A map may show an aerial view of a retail location. Alternatively, or in addition, a map may show a front facing shelf view.

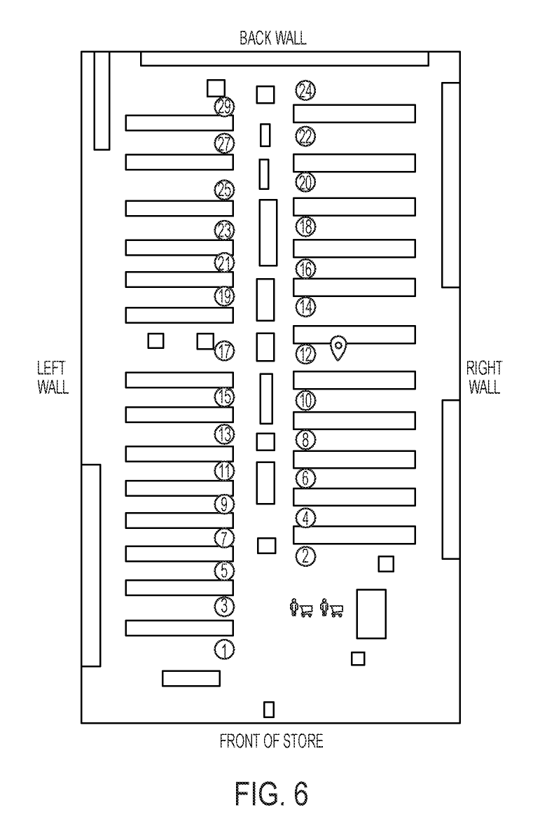

The system may modify 508 the retrieved map to include an indication of the location of the identified product in the retail location. For instance, the system may modify a map to show an indication of the identified product at the coordinates associated with the planogram to which the identified product belongs. In various embodiments, the system may modify a map by embedding metadata in the SVG+XML document for the map showing the location of the identified product. The map may be one showing an aerial view of product location in a retail location such as illustrated in FIG. 6.

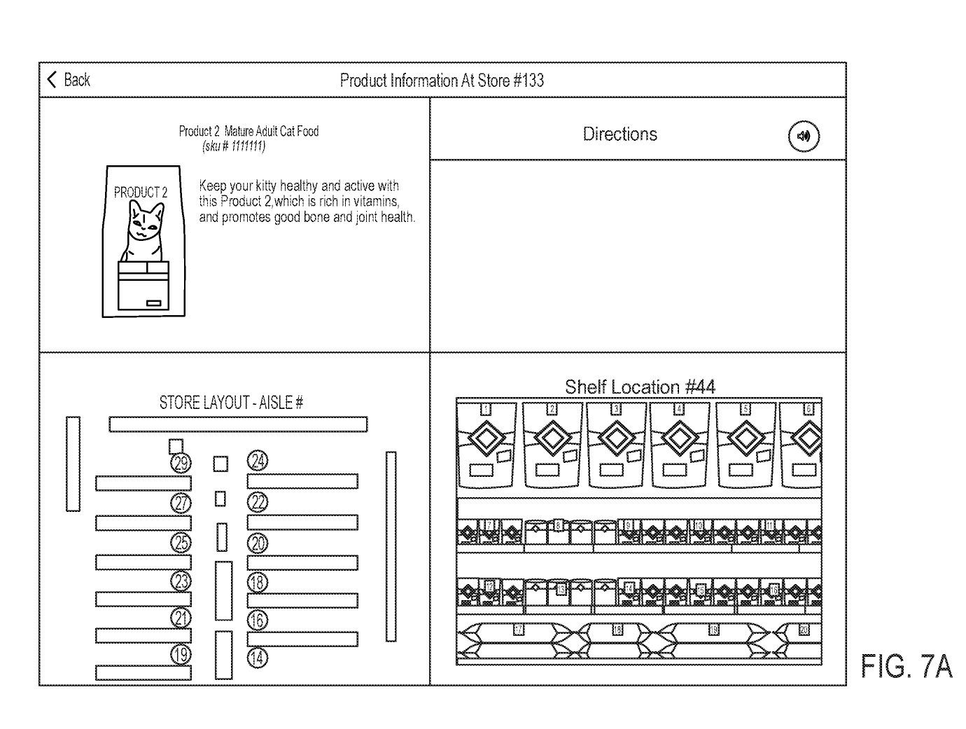

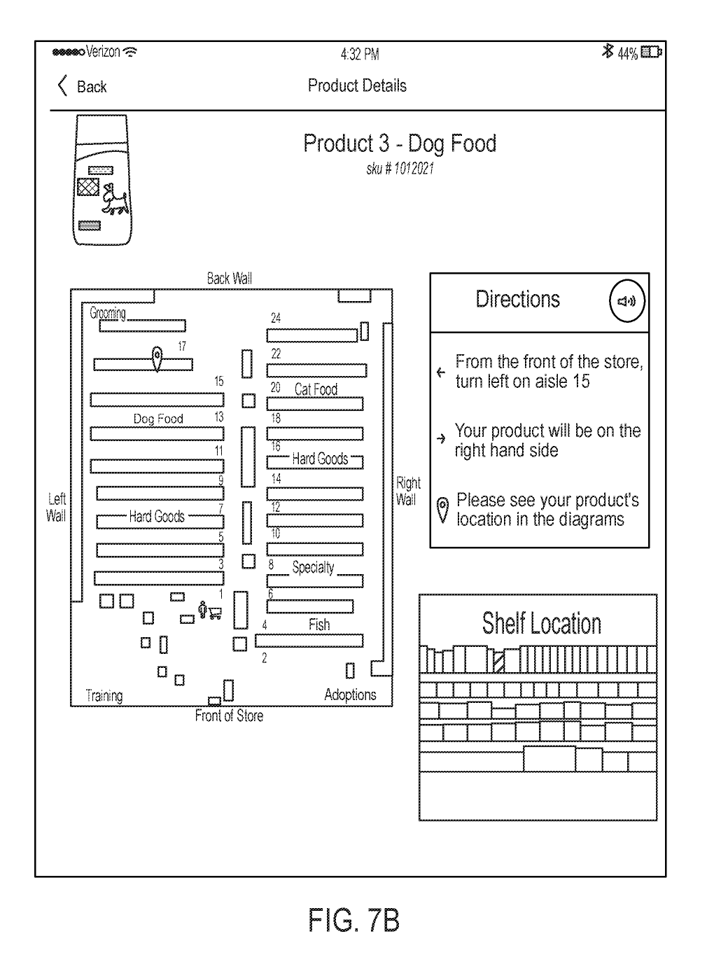

A system may modify 508 a map showing a front-facing shelf view of the planogram to which the identified product belongs to show the location of the identified product within the planogram. For example, the system may modify 508 a front-facing shelf view map to include an indicator representing the coordinates of the identified product within the planogram. FIG. 7B illustrates an example front-facing shelf view map according to an embodiment.

An indication may be a visual indication of where the identified product is located, such as, for example, a flag, a symbol, a color and/or the like. The indication may show the relative location of a product to one or more displays. For instance, an indication may show the location of a product relative to an aisle (e.g., near end of an aisle, middle of an aisle, far end of an aisle). FIG. 6 illustrates an example map showing the location of a particular product according to an embodiment.

The system may cause 510 the map showing the location of the identified product to be displayed to a user. The map may be displayed to a user via a display device of an electronic device.

In an embodiment, a system may generate directions to the location of the identified product. The system may identify a start location from which the directions are provided. The start location may be a static location, such as the front or entrance to the retail location. Alternatively, the start location may be a user's current location within a retail location.

A retail location may include wireless access points throughout at least a portion of the retail location. A wireless access point refers to a hardware electronic device that permits a wireless enabled electronic device to connect to a wired network. A wireless access point may be a standalone device which is positioned at various locations in a retail location. Alternatively, a wireless access point may be a component of a router which is similarly positioned throughout a retail location.

A product location system may determine which wireless access point a client electronic device is accessing in a retail location. A product location system may maintain or have access to a data store that includes a listing of electronic device/wireless access point connections. The product location system may search the list for the unique identifier of a client electronic device, and may identify a wireless access point to which it is connected. The product location system may use the location of the wireless access point to which the client electronic device is connected as a start location for purposes of providing directions.

The system may determine a route from the start location to the location of the identified product. The system may apply one or more route planning or pathfinding algorithms to a map to determine a route from the start location to the location of the identified product. The route may be a shortest possible route, taking into account the placement of displays, shelving, etc. The system may provide the directions to a user. The directions may be provided as text, such as written turn-by-turn directions from the start location to the location of the identified product. The directions may be provided in an audio format. For instance, one or more audio files containing directions from the start location to the location of the identified product may be played to a user via one or more speakers of a user's client electronic device. The system may generate audio files by translating written directions to an audio format.

The directions may direct a user to a pinpoint position for a certain product. For instance, directions may inform a user that a product is located on the 5^{th} row of the display. The system may obtain this location information from a product placement data store.

In an embodiment, the system may retrieve an image associated with the location of the identified product. The image may be one showing the positioning or location of the identified product on a shelf or other display. For example, an image may be a portion of a planogram showing the position or location of the identified product on a shelf or display. As another example, the image may be a photograph showing a position or location of the identified product on a shelf or other display.

A system may retrieve an image from one or more data stores where product placement information is stored. As discussed above, product placement information may be stored such that it is associated with a particular product and a particular retail location. A system may search a data store for product placement information associated with the identified product and the identified retail location, and may retrieve an image from the product placement information. The system may cause the retrieved image to be displayed to a user via a client electronic device.

In various embodiments, a system may retrieve a product description associated with an identified product. The product description may describe the identified product in more detail, explain intended uses of the identified product, provide instructions for using the identified product, and/or the like. The system may retrieve a product description from a product data store.

FIG. 7A illustrates an example of a graphical user interface (GUI) that may be displayed to a user of a product locating program according to an embodiment. As illustrated by FIG. 7A, a product description, directions, a map showing the location of an identified product and an image of the identified product location (for an identified retail location) may be displayed as part of the same GUI. It is understood that any combination of these features may be displayed as part of a GUI within the scope of this disclosure. It is also understood that any of these features may be displayed via individual or separate GUIs within the scope of this disclosure. FIG. 7B illustrates another example GUI that may be displayed to a product locating program according to an embodiment. As illustrated by FIG. 7B, the GUI may include a planogram or other front-facing shelf-view of a product's location.

In various embodiments, a system may cause a product description, a map showing the location of a product, directions to a location of a product and/or an image of a product at a product location to be displayed to a user in response to a user activating a hyperlink or other link. For example, a system may send a user an email with a hyperlink that, when selected, causes information associated with one or more products to be displayed to the user. A system may send email only to users who have agreed to receive communications from a retailer.

An email may be sent to a user for various reasons. For instance, a system may send an email to a user if the user's home retail location has been renovated or reorganized and the location of products or other merchandise has been changed. The message may inform the user of the changes and where to find one or more products in the new layout or configuration. As another example, an email message may be sent to a user if the user changes or updates the user's home retail location.

An email message may include one or more hyperlinks associated with one or more products that a user has previously purchased from a retailer. The products may be one that the user has previously purchased from a specific retail location. For instance, a system may access a historical purchase data store to identify one or more products that a certain user has purchased. The system may identify one or more products that a user has purchased over a certain period of time. The system may identify one or more products that a user has purchased from a particular retail location.

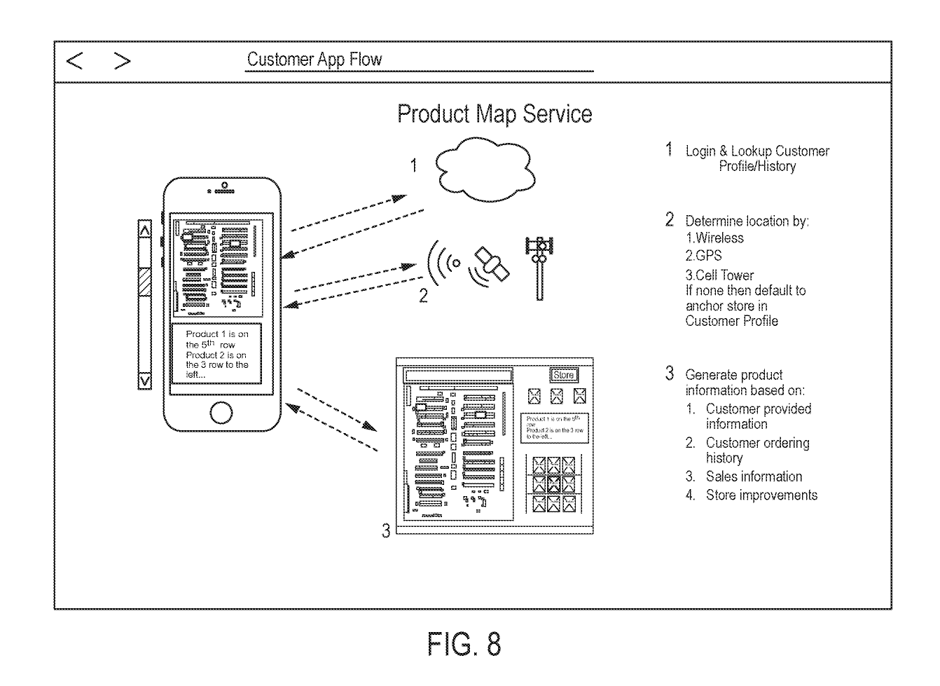

For one or more of the products, the system may generate an email message to the user. For one or more of the previously purchased items, the system may generate a hyperlink to information about the previously purchased item at a particular retail location and may embed the hyperlink in an email message to a user. Selecting the hyperlink may redirect the user to a website or may open a product locating program, and information pertaining to the location of the product in the retail locating may be displayed to the user. For example, a GUI like that illustrated in FIG. 7 may be presented to the user. FIG. 8 illustrates a diagram showing an example location service according to an embodiment.

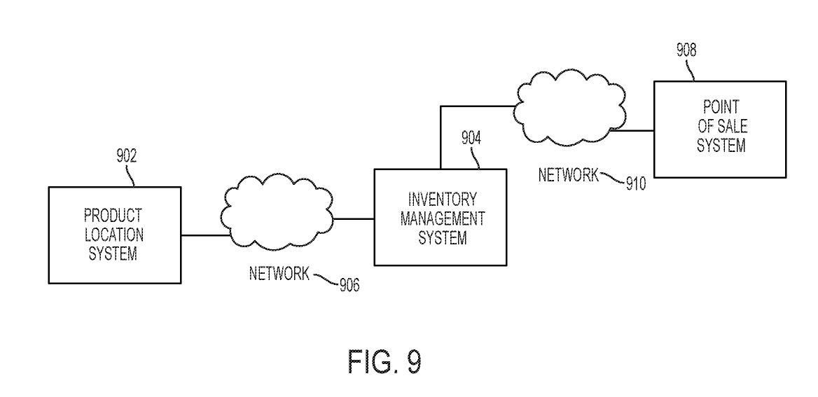

In various embodiments, a product location system may be in communication with an inventory management system. FIG. 9 illustrates a diagram showing an example of such system 900 according to an embodiment. An inventory management system 904 and product location system 902 may communicate via one or more communication networks 906.

An inventory management system may store, monitor and track inventory of product across one or more retail locations. An inventory management system may track an on-shelf inventory, the amount of inventory that is in a stock room, warehouse and/or the like. The inventory management system may be in communication with a point of sale (POS) system 908 via a communication network 910. Alternatively, a POS system 908 may be a component of the inventory management system.

The POS system 908 may track purchases of products, and may send purchase information associated with such purchases to the inventory management system 904. Purchase information may include an indication of the product(s) that are sold, a quantity of each product that is sold, a time of purchase, an indication of the retail location where the product(s) are purchased and/or the like. The inventory management system 904 updates its records based on the purchase information it receives to reflect an up-to-date inventory at the retail locations.

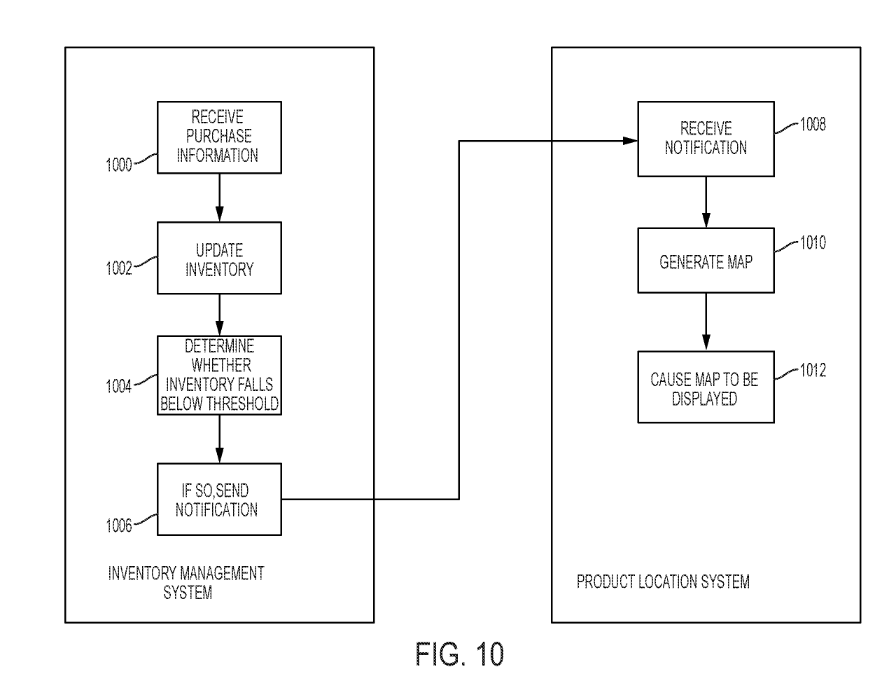

FIG. 10 illustrates an example method of generating an inventory alert according to an embodiment. As illustrated in FIG. 10, an inventory management system receives 1000 purchase information from a POS system. The inventory management system updates 1002 its records based on the purchase information. For example, the inventory management system may decrement the inventory of products for a particular retail location based on the received purchase information. For example, an inventory management system may receive purchase information indicating that two products having SKU#3824990 were sold at Retail Location 1. The inventory management system maintains a product inventory data store that indicates that Retail Location 1 currently has 42 products with that SKU. The inventory management system decrements this number by the number sold to update its records to reflect that Retail Location 1 now has 40 products with that SKU. An inventory management system may likewise update 1002 its product inventory products that are added to the inventory of a retail location. For example, if a retail location receives a new shipment of inventory, if products are returned to a retail location and can be resold, and/or the like.

An inventory management system may determine 1004 whether an amount of on-shelf inventory of a product at a retail location falls below a certain threshold value. In response to determining that an amount of on-shelf inventory falls below a threshold value, an inventory management system may send 1006 a notification to a product location system. The notification may include information identifying the product(s) having a low inventory. This information may include a SKU number or other unique product identifier.

The product location system receives 1008 the notification. The product location generates 1010 a map showing the location of the product or products indicated in the notification at the pertinent retail location. The product location may generate a map in a manner similar to that described above.

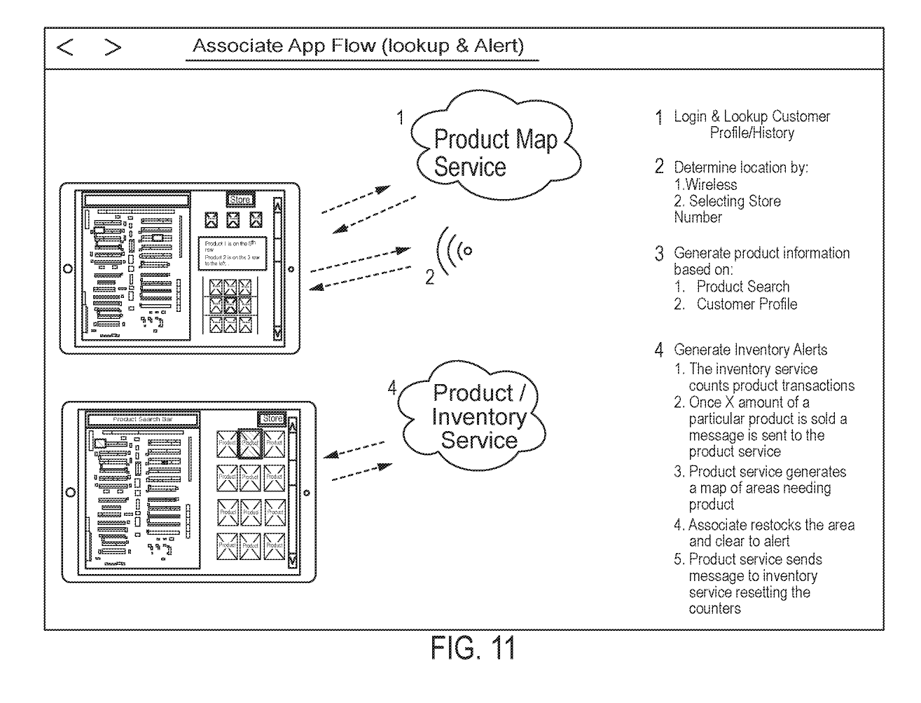

A product location system may cause 1012 the map to be displayed on one or more client electronic devices associated with one or more employees or representatives of the retail location such as, for example, retail associates for the retail location. For instance, a product location system may have access to a data store indicating which client electronic devices are associated with which retail locations. Client electronic devices may be associated with unique identifiers, Internet Protocol (IP) addresses and/or the like. The product location may identify one or more client electronic devices associated with the retail location, and may cause 1012 the map to be displayed on those client electronic devices. The product location system may also cause a notification of low inventory for the product to be displayed at the client electronic devices. FIG. 11 illustrates an example notification system according to an embodiment.

After an associate has restocked the inventory, the associate may clear the notification. The associate may clear the notification by providing input to the associate's client electronic device. For example, an associate may make a selection on a GUI, press a button, swipe the notification and/or the like to clear the notification. In response, the client electronic device may send a notification to the product location system that the inventory has been restocked. The product location system may send a notification to the inventory management system that the inventory has been restocked.

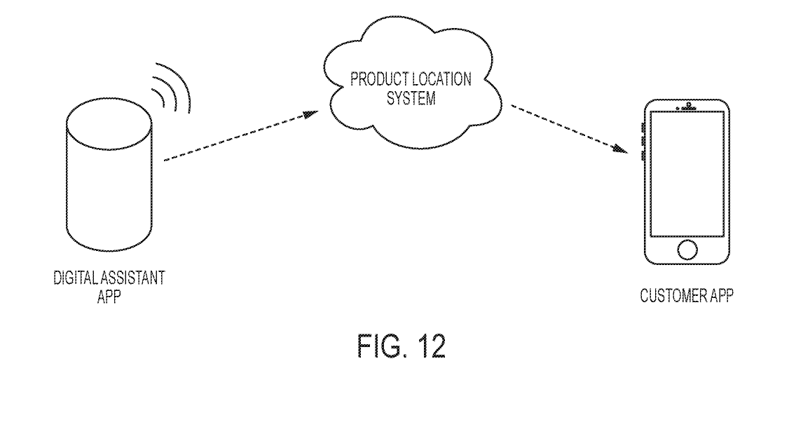

In various embodiments, a product location system may be in communication with an electronic digital assistant (or virtual assistant) application, as illustrated in FIG. 12. An electronic digital assistant (or virtual assistant) application refers to an application program that understands natural language and completes electronic tasks for a user.

An example of such a task is asking an electronic digital assistant to create a to-do list for a user. A to-do list refers to a list of tasks that a user wants to accomplish. An example of a to-do list may be a shopping list.

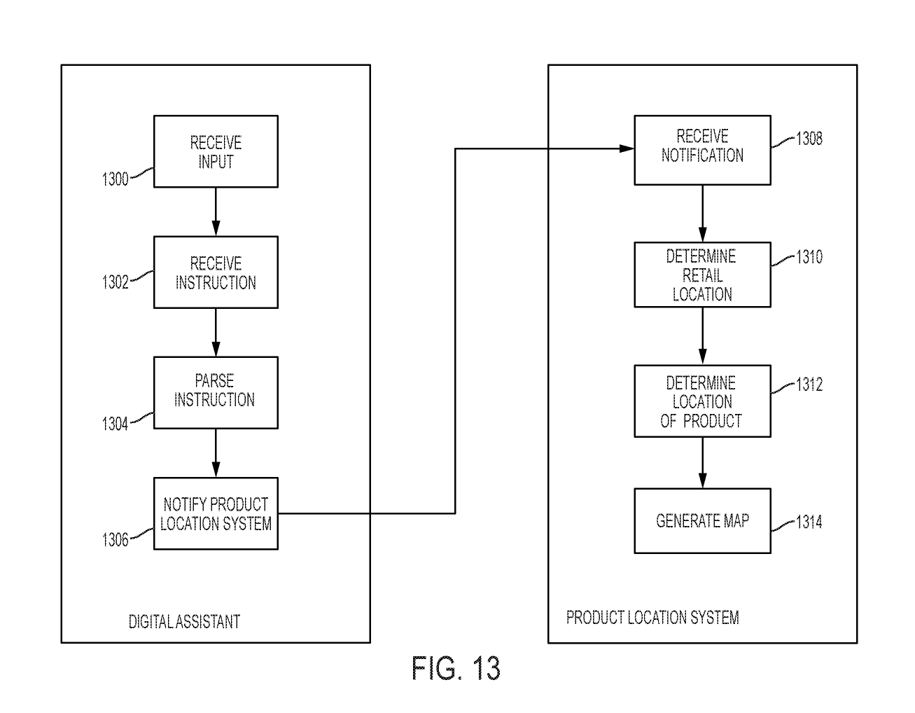

FIG. 13 illustrates an example method of generating a map in connection with a to-do list according to an embodiment. An electronic digital assistant may receive 1300 input from a user to begin a to-do list. The user may instruct the electronic digital assistant to add buying dog food at a retail location to the to-do list. In certain embodiments, the user may specify the dog food that is to be bought by, for example, the name of the dog food, the brand of the dog food and/or the like. Alternatively, the user may simply specify dog food.

The digital electronic assistant may receive 1302 the instruction, and may parse 1304 the instruction. The electronic digital assistant may parse 1304 the instruction to determine if the instruction includes one or more trigger words. A trigger word refers to a word or phrase that indicates to an electronic digital assistant that a product location system for a certain retailer should be contacted. One or more trigger words may be identified by a user by configuring one or more settings of an electronic digital assistant. For instance, a user may configure a setting of the electronic digital assistant to indicate that “dog food” and “cat food” are trigger words for Retail Location X. As another example, the name of a retail location may be a trigger word. Additional and/or alternate trigger words may be used within the scope of this disclosure.

In response to determining that the instruction includes one or more trigger words, the electronic digital assistant may notify 1306 a product location system associated with the relevant retailer or retail location. For instance, an electronic digital assistant may send a notification to a product location system. The notification may include an indication of the user and the instruction. The user indication may be an identifier that identifies the user to the product location system such as, for example, a name, a user name or other unique identifier.

The product location system may receive 1308 the notification. The product location system may identify one or more products as specified in the notification. For example, if the notification simply includes a user identifier and the trigger word “dog food”, the product location system may access the historical purchase data store to determine what dog food the user has previously purchased or most recently purchased. If the notification includes a certain brand or type of dog food, the product location system may search a product data store using the information from the notification to identify the product.

The product location system may determine 1310 a relevant retail location for the purchase. The product location system may determine that the retail location where the user previously purchased the product is the relevant retail location. As another example, a product location system may determine that the user's home retail location is the relevant retail location. As yet another example, a product location system may determine a currently location of the user's client electronic device. For instance, a product location program of the user's client electronic device may access a GPS or other location tracker of the client electronic device and may send the location to the product location system. The product location system may determine that a retail location that is closest in proximity to the user's current location is the relevant retail location.

The product location system may determine 1312 a location of the identified product at a relevant retail location, and may generate 1314 a map for that retail location showing the location of the product as described above. The product location system may cause 1314 the map to be displayed to the user. For instance, the product location system may cause the map (and/or one or more directions) to be displayed to the user when the user opens the product location program via a client electronic device. As another example, a product location system may cause the map to be displayed at the client electronic device when the product location system determines that the client electronic device is within a certain distance from the retail location. For instance, a product location program of the user's client electronic device may access a GPS or other location tracker of the client electronic device and may send the location to the product location system. If the user's current location is within a certain distance from a the retail location, the product location system may cause the map to be displayed at the client electronic device. As another example, the product location system may cause a notification to be displayed at the user's client electronic device notifying the user that a map is available.

In various embodiments, a system may use an electronic shopping list to determine a preferred route for a shopper to follow through a retail location to purchase the items on the shopping list. A product location program may include shopping list functionality that allows a user to create a shopping list for a retail location. A user may select or otherwise identify one or more products to shop for at a retail location, and a product location program may create a shopping list of the products. For instance, product location program may allow a user to search for one or more products, or select one or more products from a listing to add to a shopping list. As another example, a product location program may receive or access a shopping list for a user that the user creates using a different program that communicates with the product location program.

The product location system determines a location for one or more products on the shopping list in the retail location as described throughout this disclosure. The system may retrieve a map of the retail location, and use route planning or pathfinding algorithms to generate directions to the location of one or more of the products in the retail location. The directions may be along a route beginning at a start location. In an embodiment, the directions may be ones that minimize a distance that needs to be walked in order to locate the products. For instance, regardless of the order that products are in on a shopping list, the system may present directions that minimize the distance that needs to be traversed. The system may also cause a visual depiction of the route to be displayed via a user electronic device such as, for example, a highlighted route shown on a map of the retail location.

As an example, a system may determine a location in a retail location for the products on a shopping list. These locations may be coordinates associated with a planogram to which a product belongs. The system may, using one or more route planning or pathfinding algorithms, a map of the retail location, and the locations of the products, determine a shortest route through the retail location in order to visit the location of each of the products on the list. The system may cause the directions to be displayed on a user's electronic device.

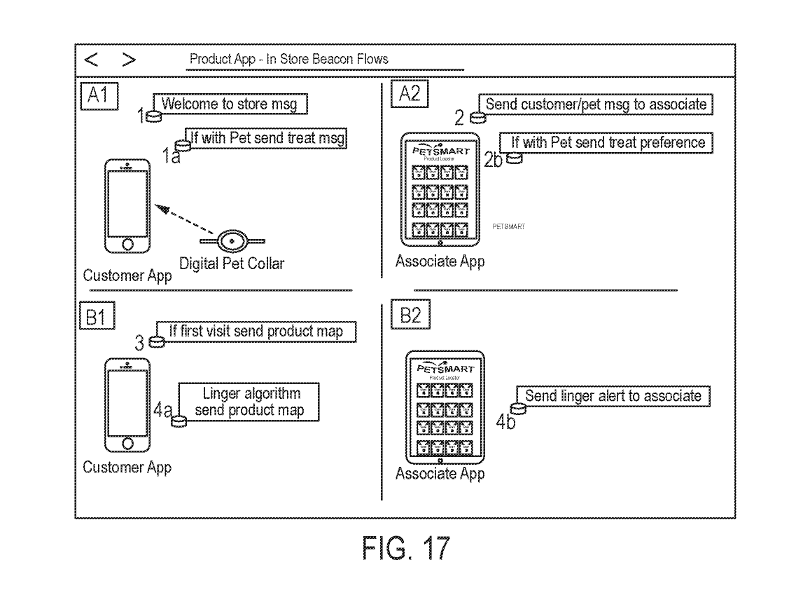

In various embodiments, a system may cause a map of a store location to be displayed to a user in response to determining that the user may need assistance locating a product. FIG. 17 illustrates example flows according to various embodiments.

For instance, as described above, a retail location may include one or more wireless access points throughout at least a portion of the retail location. When a user enters a retail location, an electronic device of the user may communicate with one or more wireless access points in the retail location. For instance, a user may configure his or her electronic device to allow communication with wireless access points. A wireless access point may detect the presence of the user's electronic device when the electronic device is within range of the wireless access point. The system may search the list for the unique identifier of a client electronic device, and may identify a wireless access point to which it is connected. The system may access a data store, such as a customer profile data store, to identify the user associated with the detected electronic device. Once the system identifies the user, the system may determine from information in the customer profile data store, the historical purchase data store and/or one or more other data stores, whether the user has ever bought products at the retail location. For instance, the system may determine whether the retail location where the user is present is user's home retail location. As another example, the system may determine from the historical purchase data store whether the user has purchased any products from the retail location over a period of time. If the system determines that the retail location is not the user's home retail location and/or that the user has not purchased any products from the retail location over a certain period of time, the system may cause a map of the retail location to be displayed to the user via the user's electronic device.

As another example, a system may cause a map of a retail location to be displayed in response to determining that a user is lingering in or around one location of a retail location for a certain period of time. For instance, a system may determine that a user's electronic device is being detected by the same wireless access point for a certain period of time, such as for example, five minutes. Additional and/or alternate time frames may be used within the scope of this disclosure. In response to determining that a user is lingering, the system may cause a map of the store and/or a front-facing shelf view map of one or more shelves in the area of the user's electronic device to be displayed via the user's electronic device.

In various embodiments, a system may send an electronic notification to an electronic device associated with one or more associates of the retail location if the system determines that a user is lingering. The notification may alert an associate that the user may need assistance.

Wireless access points may communicate with devices other than user electronic devices according to various embodiments. For instance, a user may bring his or her pet to a pet store retail location. The pet may wear an electronic collar, which may communicate with one or more wireless access points while in the retail location. In response to detecting an electronic collar, a system may send a notification to an electronic device of one or more associates in the retail location. The notification may alert the associates that a pet is present in the retail location. The associate may, in turn, present the pet with a treat or otherwise attend to the pet and/or the user.

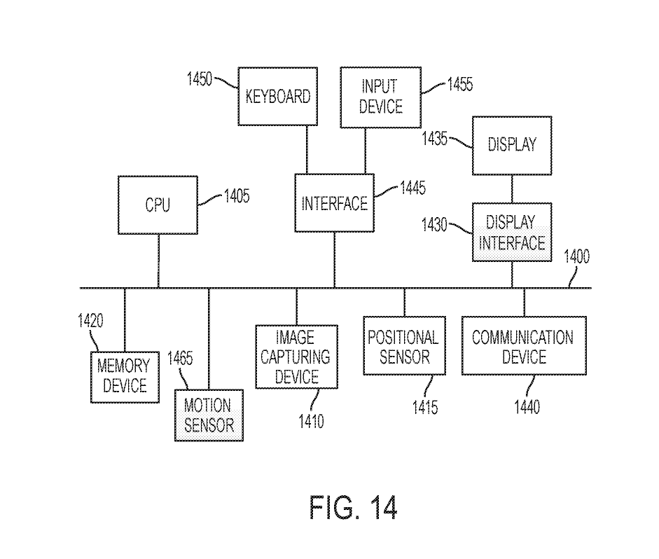

FIG. 14 depicts a block diagram of hardware that may be used to contain or implement program instructions, such as those of a cloud-based server, electronic device, virtual machine, or container. A bus 1400 serves as an information highway interconnecting the other illustrated components of the hardware. The bus may be a physical connection between elements of the system, or a wired or wireless communication system via which various elements of the system share data. Processor 1405 is a processing device that performs calculations and logic operations required to execute a program. Processor 1405, alone or in conjunction with one or more of the other elements disclosed in FIG. 14, is an example of an electronic device, processing device, computing device or processor as such terms are used within this disclosure. The processing device may be a physical processing device, a virtual device contained within another processing device, or a container included within a processing device. A processing device may be a microprocessor or microcontroller.

A memory device 1420 is a hardware element or segment of a hardware element on which programming instructions, data, or both may be stored. Read only memory (ROM) and random access memory (RAM) constitute examples of memory devices, along with cloud storage services, and flash memory.

An optional display interface 1430 may permit information to be displayed on the display 1035 in audio, visual, graphic or alphanumeric format. Communication with external devices, such as a printing device, may occur using various communication devices 1440, such as a communication port or antenna. A communication device 1440 may be communicatively connected to a communication network, such as the Internet or an intranet.

The hardware may also include a user input interface 1445 which allows for receipt of data from input devices such as a keyboard or keypad 1455, or other input device 1455 such as a mouse, a touch pad, a touch screen, a remote control, a pointing device, a video input device and/or a microphone. Data also may be received from an image capturing device 1410 such as a digital camera or video camera. A positional (or location) sensor 1415 and/or motion sensor 1165 may be included to detect position and movement of the device. Examples of motion sensors 1065 include gyroscopes or accelerometers. An example of a positional (or location) sensor 1415 is a global positioning system (GPS) sensor device that receives positional data from an external GPS network. The hardware may also include output devices, such as, for example one or more speakers.

The features and functions described above, as well as alternatives, may be combined into many other different systems or applications. Various alternatives, modifications, variations or improvements may be made by those skilled in the art, each of which is also intended to be encompassed by the disclosed embodiments.

What is claimed is:

1. A product location system comprising:
a computing device; and
a computer-readable storage medium comprising one or more programming instructions that, when executed, cause the computing device to:
identify a retail location associated with a retailer,
receive an indication of a target product that is to be located in the retail location, wherein the product location system receives the indication from a product location program of a client electronic device that is in communication with the computing device via a communication network,
query a product data store using the indication to identify the target product and a location of the target product in the retail location,
retrieve a map of the retail location, wherein the map comprises one or more electronic files and embedded metadata,
modify the map to include a visual indication associated with location of the target product, and
cause the modified map to be displayed via the client electronic device such that the visual indication showing the location of the target product in the retail location is visible to a user via the client electronic device.

2. The product location system of claim 1, wherein the computer-readable storage medium further comprises one or more programming instructions that, when executed, cause the computing device to generate the map of the retail location.

3. The product location system of claim 2, wherein the one or more programming instructions that, when executed, cause the computing device to generate the map of the retail location comprise one or more programming instructions that, when executed, cause the computing device to:
obtain physical data associated with the retail location;
obtain product placement information associated with the retail location, wherein the product placement information comprises one or more planograms;
group the one or more planograms into one or more groupings;
apply one or more rotations to one or more planograms of the one or more groupings;
create one or more aisle objects, wherein each aisle object comprises an indication of one or more groupings that comprise a side of an aisle of the retail location;
embed a unique identifier as metadata in the aisle object, wherein the unique identifier corresponds to an aisle number in the retail location; and
create the map, wherein the map comprises a scalable vector graphic and extensible markup language document that includes one or more of the planograms and the aisle objects.

4. The product location system of claim 1, wherein the one or more programming instructions that, when executed, cause the computing device to identify a retail location comprise one or more programming instructions that, when executed, cause the computing device to:
receive a current location from a location sensor of the client electronic device; and
identify one or more retail locations by searching a retail location data store for one or more retail locations within a certain distance from the current location.

5. The product location system of claim 4, wherein the computer-readable storage medium further comprises one or more programming instructions that, when executed, cause the computing device to select the retail location in closest proximity to the current location.

6. The product location system of claim 1, wherein the one or more programming instructions that, when executed, cause the computing device to identify a retail location comprise one or more programming instructions that, when executed, cause the computing device to:
identify a user associated with the client electronic device; and
identify a home retail location from a customer profile associated with the user.

7. The product location system of claim 1, wherein the one or more programming instructions that, when executed, cause the computing device to receive an indication of a target product to be located comprise one or more programming instructions that, when executed, cause the computing device to receive, from the client electronic device, a universal product code associated with the target product.

8. The product location system of claim 1, wherein:
the one or more programming instructions that, when executed, cause the computing device to receive the indication of a target product to be located comprise one or more programming instructions that, when executed, cause the computing device to receive, from the client electronic device, one or more search terms for the target product that were provided to the client electronic device as typed text, and
the one or more programming instructions that, when executed, cause the computing device to query the product data store using the indication to identify the target product comprise one or more programming instructions that, when executed, cause the computing device to query the product data store using one or more of the one or more search terms.

9. The product location system of claim 1, wherein:
the one or more programming instructions that, when executed, cause the computing device to receive the indication of a target product to be located comprise one or more programming instructions that, when executed, cause the computing device to receive, from the client electronic device, one or more search terms for the target product that were provided to the client electronic device as spoken input; and
the one or more programming instructions that, when executed, cause the computing device to query the product data store using the indication to identify the target product comprise one or more programming instructions that, when executed, cause the computing device to query the product data store using one or more of the typed search terms.

10. The product location system of claim 1, wherein the one or more programming instructions that, when executed, cause the computing device to receive the indication of a target product to be located comprise one or more programming instructions that, when executed, cause the computing device to:
identify a user associated with the client electronic device; and
search a historical purchase data store for one or more products previously purchased by the user from the retailer.

11. The product location system of claim 1, wherein the computer-readable storage medium further comprises one or more programming instructions that, when executed, cause the computing device to:
identify a start location;
generate a set of directions from the start location to the location of the target product; and
cause the set of directions to be displayed via the client electronic device.

12. A method, comprising:
by a computing device of a product location system:
identifying a retail location associated with a retailer,
receiving an indication of a target product that is to be located in the retail location from a product location program of a client electronic device that is in communication with the computing device via a communication network,
querying a product data store using the indication to identify the target product and a location of the target product in the retail location,
retrieving a map of the retail location, wherein the map comprises one or more electronic files and embedded metadata,
modifying the map to include a visual indication associated with location of the target product, and
causing the modified map to be displayed via the client electronic device such that the visual indication showing the location of the target product in the retail location is visible to a user via the client electronic device.

13. The method of claim 12, further comprising generating the map of the retail location.

14. The method of claim 13, wherein generating the map of the retail location comprises:
obtaining physical data associated with the retail location;
obtaining product placement information associated with the retail location, wherein the product placement information comprises one or more planograms;
grouping the one or more planograms into one or more groupings;
applying one or more rotations to one or more planograms of the one or more groupings;
creating one or more aisle objects, wherein each aisle object comprises an indication of one or more groupings that comprise a side of an aisle of the retail location;
embedding a unique identifier as metadata in the aisle object, wherein the unique identifier corresponds to an aisle number in the retail location; and
creating the map, wherein the map comprises a scalable vector graphic and extensible markup language document that includes one or more of the planograms and the aisle objects.

15. The method of claim 12, wherein causing the computing device to identify a retail location comprises:
receiving a current location from a location sensor of the client electronic device; and
identifying one or more retail locations by searching a retail location data store for one or more retail locations within a certain distance from the current location.

16. The method of claim 15, further comprising causing the computing device to select the retail location in closest proximity to the current location.

17. The method of claim 12, wherein identifying a retail location comprises:
identifying a user associated with the client electronic device; and
identifying a home retail location from a customer profile associated with the user.

18. The method of claim 12, wherein receiving an indication of a target product to be located comprises receiving, from the client electronic device, a universal product code associated with the target product.

19. The method of claim 12, wherein:
receiving the indication of a target product to be located comprises receiving, from the client electronic device, one or more search terms for the target product that were provided to the client electronic device as typed text, and
querying the product data store using the indication to identify the target product comprises querying the product data store using one or more of the one or more search terms.

20. The method of claim 12, wherein:
receiving the indication of a target product to be located comprises receiving, from the client electronic device, one or more search terms for the target product that were provided to the client electronic device as spoken input; and
querying the product data store using the indication to identify the target product comprises querying the product data store using one or more of the typed search terms.

21. The method of claim 12, wherein receiving the indication of a target product to be located comprises:
identifying a user associated with the client electronic device; and
searching a historical purchase data store for one or more products previously purchased by the user from the retailer.

22. The method of claim 12, further comprising:
identifying a start location;
generating a set of directions from the start location to the location of the target product; and
causing the set of directions to be displayed via the client electronic device.
